(19) United States
(12) Patent Application Publication
(10) Pub. No.: US 2021/0224819 A1
(43) Pub. Date: Jul. 22, 2021

(54) CARBON FOOTPRINT TRACKER

(71) Applicant: International Business Machines Corporation, Armonk, NY (US)

(72) Inventors: Zachary A. Silverstein, Jacksonville, FL (US); Kristen Zelenka Lee, Austin, TX (US); Naga ManojKasyap Chilakamarthy Venkata, Austin, TX (US); Natalie Watkins, Austin, TX (US)

(21) Appl. No.: 16/744,353

(22) Filed: Jan. 16, 2020

(51) Int. Cl. G06Q 30/00; G06F 16/23; G06F 16/25; G06Q 30/06; G06Q 50/04; G06Q 50/28

(52) U.S. Cl. CPC G06Q 30/018; G06F 16/2379; G06F 16/252; G06Q 30/0631; G06Q 50/26; G06Q 50/04; G06Q 50/28; G06Q 30/0623; G06Q 30/0641

(57) ABSTRACT

In an approach to carbon footprint tracking, responsive to determining that a transaction to purchase an item for a user is detected by a computer, a total carbon emissions for the original item is calculated. One or more alternatives to the original item are located. The total carbon emissions for each alternative to the original item is calculated. The user is notified of the total carbon emissions for the original item and the total carbon emissions for each alternative to the original item where the carbon emissions are lower for the alternative item than for the original item. An indication of a final item chosen by the user is received, where the final item is either the original item or one of the alternative items.

### BACKGROUND

The present invention relates generally to the field of reduction of greenhouse gas emissions, and more particularly to carbon footprint tracking.

A carbon footprint is the amount of greenhouse gases—primarily carbon dioxide—released into the atmosphere by a particular human activity. A carbon footprint includes direct emissions, such as from driving a car, as well as whatever emissions are required to consume any goods and services. A carbon footprint can be a broad measure or be applied to the actions of an individual, a family, an event, an organization, or even an entire nation. Often, a carbon footprint includes the measure of other greenhouse gas emissions as well. Reducing carbon dioxide emissions as much as possible will help to reduce the negative effects of carbon footprints.

Business transactions that take place on the internet are called e-commerce, short for “electronic commerce.” Popular examples of e-commerce generally involve buying and selling online, but the e-commerce universe contains other types of activities as well. Basically, any form of business transaction conducted electronically can be referred to as e-commerce. Those involved in the transactions can represent multiple combinations of customers, businesses, vendors or other suppliers, or government agencies. Business-to-consumer transactions are what often come to mind when people think of e-commerce. One of the most popular examples of business-to-consumer transactions is buying and selling goods on the internet.

### SUMMARY

Embodiments of the present invention disclose a method, a computer program product, and a system for carbon footprint tracking. In one embodiment, responsive to determining that a transaction to purchase an item for a user is detected by a computer, a total carbon emissions for the original item is calculated. One or more alternatives to the original item are located. The total carbon emissions for each alternative to the original item is calculated. The user is notified of the total carbon emissions for the original item and the total carbon emissions for each alternative to the original item where the carbon emissions are lower for the alternative item than for the original item. An indication of a final item chosen by the user is received, where the final item is either the original item or one of the alternative items.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of the carbon tracker program, on a computing device within the distributed data processing environment of FIG. 1, for a carbon footprint tracker, in accordance with an embodiment of the present invention.

FIG. 3 depicts a block diagram of components of the computing device executing the carbon tracker program within the distributed data processing environment of FIG. 1, in accordance with an embodiment of the present invention.

### DETAILED DESCRIPTION

Sustainability and the threat of carbon emissions is a critical issue that must be addressed. There are a number of groups, from nonprofit organizations to large businesses, working on methods to offset carbon emissions in the form of carbon credits. Carbon neutrality, or having a net zero carbon footprint, refers to achieving net zero carbon emissions by balancing a measured amount of carbon released with an equivalent amount sequestered or offset. But these solutions are targeted to government agencies to large corporations, not the individual consumer.

In point of purchase situations, including e-commerce, there is an opportunity to understand the carbon impact different consumer goods have on the environment. Most such calculators today, however, are used after the purchase of an item. The present invention enables individuals to understand, calculate, and track the carbon impact of their purchasing decisions before the sale, thereby changing online shopping habits to account for carbon emissions and reducing the carbon footprint.

As referred to herein, all data retrieved, collected, and used, is used in an opt in manner, i.e., the data provider has given permission for the data to be used. For example, the installation procedure for a smart phone app that would be used to collect carbon emissions data could include an option that must be selected by the owner to allow use of the data. As another example, the carbon tracker program could request approval from the owner of the device before collecting the data. Any data or information used for which the provider has not opted in is data that is publicly available.

The present invention enables carbon-saving options (like location-based suggestions) to be presented to a user at the point of purchase. The system accounts for shipping and logistics practices, as well the carbon footprint of the item itself. Further, the system is able to report carbon emissions to a prospective buyer as well as recommend similar, carbon-saving alternatives at the point of sale, whether online or at a physical point of purchase. In addition, embodiments of the present invention will aggregate the carbon footprint of the transactions by the user over time, and present this information to the user, either at the time of a pending transaction, to possibly affect the purchase decision, or as a report of aggregate carbon emissions over time, to allow the user to track his or her carbon emissions trends and carbon footprint reduction progress.

The system estimates the carbon footprint of a prospective item to be purchased from various sources. These sources include the original manufacturer (for the carbon emissions associated with the manufacturing of the product); shipping location (to determine the distance the product must travel for delivery, and the amount of carbon emissions associated with the travel distance); mode of transportation (to determine, for example, a per-mile amount of carbon emissions); proximity of end customer to nearest warehouse (if the product is already in a warehouse); time of shipping; packaging materials; and the possibility of bundling items.

The system captures supply chain logistical information and practices to derive carbon footprint for a given product, as well as related selections the user can make, with regards to footprint optimization on an e-commerce platform. Carbon credits, which put a price on carbon reductions and provide revenue for environmental projects, and which can be traded as a form of currency, represent a clear way in which companies and individuals can be empowered to reduce or offset the negative or unavoidable impact of their purchasing choices on the environment. However, critics of the carbon credit trading system usually point to its lack of transaction traceability, differing laws and jurisdictions, and potential for double counting. The transparency of blockchain offers solutions that solve these problems, potentially allowing a feasible carbon trading system. Blockchain is a digital ledger in which transactions are recorded chronologically and publicly. Applying this to carbon credits to create a “carbon currency” can avoid the issues associated with carbon credits and consolidate the carbon market. Carbon credits are a perfect candidate for a digital currency as they are data-driven, rely on multiple approval steps and exist separately to the physical impacts to which they correlate.

The present invention is a method, computer program product, and system for a carbon footprint tracker.

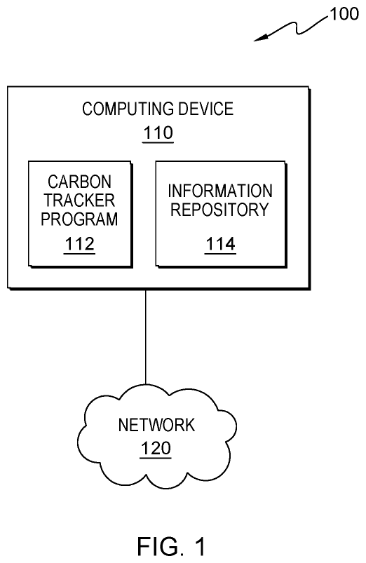

FIG. 1 is a functional block diagram illustrating a distributed data processing environment, generally designated 100, suitable for operation of carbon tracker program 112 in accordance with at least one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110 connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between computing device 110 and other computing devices (not shown) within distributed data processing environment 100.

Computing device 110 can be a standalone computing device, a management server, a web server, a mobile computing device, or any other electronic device or computing system capable of receiving, sending, and processing data. In an embodiment, computing device 110 can be a smart phone, a laptop computer, a tablet computer, a netbook computer, a personal computer (PC), a desktop computer, a personal digital assistant (PDA), or any programmable electronic device capable of communicating with other computing devices (not shown) within distributed data processing environment 100 via network 120. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers, etc.) that act as a single pool of seamless resources when accessed within distributed data processing environment 100.

In an embodiment, computing device 110 includes carbon tracker program 112. In an embodiment, carbon tracker program 112 is a program, application, or subprogram of a larger program for carbon footprint tracking. In an alternative embodiment, carbon tracker program 112 may be located on any other device accessible by computing device 110 via network 120.

In an embodiment, computing device 110 includes information repository 114. In an embodiment, information repository 114 may be managed by carbon tracker program 112. In an alternate embodiment, information repository 114 may be managed by the operating system of the device, alone, or together with, carbon tracker program 112. Information repository 114 is a data repository that can store, gather, compare, and/or combine information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, user data, carbon emissions database data, commerce history data (e.g., item return rate), item supply chain history data, item nutritional or content data (e.g., aluminum, plastic, high fructose corn syrup, etc.) and other data that is received by carbon tracker program 112 from one or more sources, and data that is created by carbon tracker program 112.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

Information repository 114 includes a database to store aggregate carbon footprint decisions over time. In an embodiment, carbon tracker program 112 creates a database, if it does not already exist, for a user of the system to store carbon emissions information for each transaction the user completes where carbon emissions can be determined. The aggregate carbon footprint database allows carbon tracker program 112 to provide the aggregate level of carbon footprint information over any time period during which carbon tracker program 112 was actively analyzing the carbon footprint information for the purchasing transactions of the user. In an embodiment, carbon tracker program 112 provides the aggregate level of carbon footprint information to the user when a transaction is pending to allow the user to make purchasing decisions based on aggregate carbon emissions data.

In an embodiment, carbon tracker program 112 creates a point system to track aggregate carbon emissions for the user. In an embodiment, the aggregate carbon footprint database stores the points used in each transaction recorded by carbon tracker program 112 for the user.

In an embodiment, carbon tracker program 112 uses blockchain technology to secure the data in the aggregate carbon footprint database.

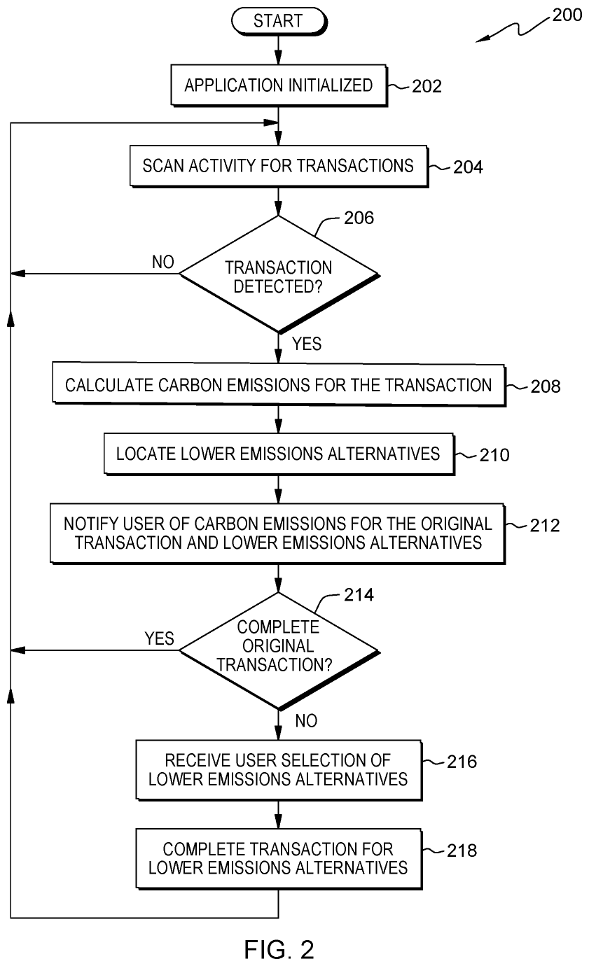

FIG. 2 is a flow chart diagram of workflow 200 depicting operational steps for carbon tracker program 112 for a carbon footprint tracker in accordance with at least one embodiment of the invention. In an alternative embodiment, the steps of workflow 200 may be performed by any other program while working with carbon tracker program 112. In an embodiment, carbon tracker program 112 initializes the application. In an embodiment, carbon tracker program 112 scans the activity on computing device 110 for commerce transactions. In an embodiment, carbon tracker program 112 determines if a commerce transaction is detected. In an embodiment, if carbon tracker program 112 determines that a commerce transaction was detected, carbon tracker program 112 calculates the total carbon emissions for the commerce transaction. In an embodiment, carbon tracker program 112 locates potential lower carbon emissions alternatives for the item in the pending transaction. In an embodiment, carbon tracker program 112 notifies the user of the total carbon emissions for the pending transaction, as well as the potential lower emissions alternatives. In an embodiment, carbon tracker program 112 determines if the user has completed the original transaction. In an embodiment, if carbon tracker program 112 determines that the user has not completed the original transaction, then carbon tracker program 112 receives the selection from the user of a lower emission alternative. In an embodiment, carbon tracker program 112 completes the transaction for the lower emissions alternative.

It should be appreciated that embodiments of the present invention provide at least for implementing a carbon footprint tracker. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

Carbon tracker program 112 initializes the application (step 202). In an embodiment, carbon tracker program 112 initializes the application by installing a plugin application into a web browser. In another embodiment, carbon tracker program 112 initializes the application by configuring a stand-alone application to monitor computing device 110 for any potential transactions. In yet another embodiment, carbon tracker program 112 initializes the application as a stand-alone program that can receive input from a user of a product to be purchased offline, such as a purchase at a brick-and-mortar store, and determine the carbon emissions of the product to be purchased, as well as potential alternative products with lower carbon emissions.

Carbon tracker program 112 scans the activity for transactions (step 204). In an embodiment, carbon tracker program 112 scans all ongoing applications on computing device 110 to determine if any potential e-commerce transactions are in process on computing device 110. In another embodiment, carbon tracker program 112 monitors a user interface to receive inputs from a user considering an in-person transaction, such as a purchase at a brick-and-mortar store. In yet another application, carbon tracker program 112 is integrated into a credit card application to monitor any transactions in the credit card application. In an embodiment, carbon tracker program 112 monitors a smart IOT shopping cart to determine that the user added an item. In an embodiment, carbon tracker program 112 monitors a smart shopping engine to determine if the user is shopping for items that may have carbon emissions associated with them.

Carbon tracker program 112 determines if a transaction is detected (step 206). In an embodiment, carbon tracker program 112 determines that an e-commerce transaction is detected on computing device 110. In another embodiment, carbon tracker program 112 determines that an in-person transaction, such as a purchase at a brick-and-mortar store, is detected. In an embodiment, if a transaction is detected, then carbon tracker program 112 continues to Step 208. If no transaction, either e-commerce or in-person, is detected, then carbon tracker program 112 returns to Step 204.

Carbon tracker program 112 calculates the carbon emissions for the transaction (step 208). At step 208, carbon tracker program 112 calculates the carbon emissions for the transaction. In an embodiment, carbon tracker program 112 performs a custom web search to estimate the carbon emissions of the item to be purchased. In another embodiment, carbon tracker program 112 searches the aggregate carbon footprint database to see if the item or a similar item was previously added to the database to estimate the carbon emissions. In an embodiment, carbon tracker program 112 calculates the total carbon emissions associated with the transaction, including the carbon emissions for the original manufacturer (for the carbon emissions associated with the manufacturing of the product); shipping location (the amount of carbon emissions associated with the travel distance); mode of transportation (e.g., a truck will have a higher per-pound-per-mile amount of carbon emissions than a train); proximity of end customer to nearest warehouse; time of shipping; packaging materials; and the possibility of bundling items.

In an embodiment, the carbon emissions for the original manufacturer include the emissions generated by the creation of the product and the actual materials use to create the product. This can also include the resources used to power the creation of the product. In an embodiment, the carbon emissions can be estimated (e.g., five pounds of plastic is used that is estimated at a footprint of 40 pounds of carbon dioxide). In another embodiment, the carbon emissions can be specific (e.g., the five pounds of plastic used was from a plant that specifically used 32 pounds of carbon dioxide).

In an embodiment, the carbon emissions for the shipping location and any warehouse in which the product is held between the time of manufacture and the actual delivery to the user includes the carbon footprint of the building storing the item after purchase. This includes efficiency and utility information of the warehouse, (e.g., the type of lighting used in the building), the amount of warehouse space the product occupies, etc.

In an embodiment, the mode of transportation includes the carbon footprint of transporting the item from the manufacturer to the warehouse (or warehouses, if the item is moved between warehouses before final delivery to the user), and from the warehouse to the delivery location for the user. In an embodiment, carbon tracker program 112 determines the carbon emissions for shipping the item to be purchased by retrieving the shopping profile of the user to determine the shipping address. In an embodiment, carbon emissions caused by the mode of transportation can include the carbon emissions caused by the idle time of the vehicle, the type of vehicle, the type of fuel used, etc.

In an embodiment, the carbon emissions can include the return rate of the user for the item to be purchased. In an embodiment, carbon tracker program 112 retrieves the frequency of return of the item to be purchased from the merchant. In another embodiment, carbon tracker program 112 determines the likelihood of returning the item to be purchased by retrieving the purchasing history of the same or similar items from the aggregate carbon footprint database. In another embodiment, carbon tracker program 112 estimates the return rate of the user for the item to be purchased. The return rate of the user for the item to be purchased is added to the calculation to determine the total carbon emissions for the item to be purchased. For example, if there is a 25% return rate on the product, then carbon tracker program 112 will calculate the carbon emissions for the return of the product to the manufacturer or seller, and add 25% of that amount of carbon emissions to the total carbon emissions for acquiring the item. In an embodiment, the return rate is calculated as the probability that the user will return the product.

In an embodiment, if the user has chosen to use the points system as described above, carbon tracker program 112 calculates the total number of points for the pending transaction from the total carbon emissions associated with the transaction.

Carbon tracker program 112 locates lower emissions alternatives (step 210). At step 210, carbon tracker program 112 performs a custom web search to locate lower emissions alternatives to the item to be purchased in the transaction. In another embodiment, carbon tracker program 112 searches the aggregate carbon footprint database to see if a similar item in the database has lower carbon emissions. In an embodiment, carbon tracker program 112 calculates the total carbon emissions associated with the alternative items, including the carbon emissions for the original manufacturer (for the carbon emissions associated with the manufacturing of the product); shipping location (the amount of carbon emissions associated with the travel distance); mode of transportation (e.g., a truck will have a higher per-pound-per-mile amount of carbon emissions than a train); proximity of end customer to nearest warehouse; time of shipping; packaging materials; and the possibility of bundling items, as in Step 208 for the originally selected item.

In an embodiment, carbon tracker program 112 determines alternative products and alternative shipping methods by checking alternatives of as many of the factors listed as possible. These factors include, for example, modifying the delivery location, modifying the delivery date, modifying the delivery packaging, and finding alternative products. In an embodiment, this could be a “related items” popup on computing device 110 that is organized to find items with a smaller carbon footprint. In an embodiment, this can include price, quality, and user profile as determinants.

In an embodiment, if the user has chosen to use the points system as described above, carbon tracker program 112 calculates the total number of points for the alternative items from the total carbon emissions associated with the alternative items.

Carbon tracker program 112 notifies the user of carbon emissions for the transaction and lower emissions alternatives (step 212). At step 212, carbon tracker program 112 notifies the user of the total carbon emissions for the proposed transaction as calculated in Step 208. In an embodiment, carbon tracker program 112 notifies the user of the lower emissions alternatives to the item to be purchased in the transaction.

In an embodiment, carbon tracker program 112 notifies the user of the total carbon emissions for the transaction by displaying a popup window on computing device 110. The popup window may, for example, highlight the item to be purchased and display the total carbon emissions calculated in step 208. In an embodiment, carbon tracker program 112 notifies the user of lower emissions alternatives by displaying a list of the alternatives on computing device 110. In another embodiment, carbon tracker program 112 notifies the user of lower emissions alternatives by, for example, sending a text message or other push notification to the user containing the lower emissions alternatives.

In an embodiment, carbon tracker program 112 notifies the user of the total carbon emissions for the transaction by displaying carbon footprint history information for similar past transactions on computing device 110. In another embodiment, carbon tracker program 112 displays carbon footprint history information based on a time period, for example, the last 90 days, on computing device 110. In yet another embodiment, carbon tracker program 112 displays the carbon footprint history information in any manner that the user selects on computing device 110.

In an embodiment, if the user has chosen to use the points system as described above, carbon tracker program 112 notifies the user of the number of points for the item in the original transaction. In an embodiment, carbon tracker program 112 notifies the user of the number of points for each lower emissions alternative item as determined in Step 210. In an embodiment, carbon tracker program 112 notifies the user of the total number of points used and the total number of points remaining for the time period selected by the user.

In an embodiment, carbon tracker program 112 sorts the display of the original transaction and the alternative lower emissions alternatives by carbon footprint. In an embodiment, the user chooses the sort order, either lowest carbon footprint first, or highest carbon footprint first. In an embodiment, carbon tracker program 112 sorts the display of the original transaction and the alternative lower emissions alternatives by points, if the user has chosen to use the points system. In an embodiment, carbon tracker program 112 notifies the user of opportunity cost information, for example, that an item at a higher price may have a significantly lower total carbon emissions, to allow the user to make a decision to reduce the carbon emissions by spending more money on the purchase.

In an embodiment, carbon tracker program 112 notifies the user of any alternative shipping methods, and the calculated carbon emissions for each alternative shipping method. In an embodiment, if carbon tracker program 112 detects multiple possible items to be purchased, then carbon tracker program 112 calculates the savings in carbon emissions by combining the purchases into fewer shipments, and notifies the user of the potential savings in carbon emissions by combining the shipments.

Carbon tracker program 112 determines if the user completes the original transaction (step 214). At step 216, carbon tracker program 112 determines whether the user has elected to complete the original transaction, rather than choose one of the lower emission alternatives. In an embodiment, carbon tracker program 112 displays the resulting overall carbon emissions data for the completed transaction for the user. Carbon tracker program 112 then records the resulting overall carbon emissions data for the completed transaction in the aggregate carbon footprint database. In an embodiment, if the user has chosen to use the points system as described above, carbon tracker program 112 will update the points in the aggregate carbon footprint database by subtracting the points determined for the original transaction, as determined in Step 208, from the remaining points available. In an embodiment, carbon tracker program 112 will notify the user of the points remaining after the transaction.

If carbon tracker program 112 determines that the user has elected to purchase one of the lower emission alternatives, then carbon tracker program 112 continues to Step 216.

In an embodiment, if the user has chosen to use carbon credits, carbon tracker program 112 calculates the supply chain carbon credit value for the original transaction.

Carbon tracker program 112 then returns to Step 204.

Carbon tracker program 112 receives the user selection of lower emissions alternative (step 216). At step 216, carbon tracker program 112 receive the user selection of one or more of the lower emissions alternatives.

Carbon tracker program 112 completes the transaction for the lower emissions alternative (step 218). At step 218, carbon tracker program 112 completes the transaction for the lower emissions alternative based on the choice received from the user. Carbon tracker program 112 then records the carbon emissions information determined in Step 210 in the aggregate carbon footprint database. In an embodiment, if the user has chosen to use the points system as described above, carbon tracker program 112 will update the points in the aggregate carbon footprint database by deducting the points determined for the alternative transaction, as determined in Step 210, from the remaining points available. In an embodiment, carbon tracker program 112 will notify the user of the points remaining after the transaction.

In an embodiment, if the user has chosen to use carbon credits, carbon tracker program 112 calculates the supply chain carbon credit value for the lower emissions alternative.

Carbon tracker program 112 then returns to Step 204.

In an example of the operation of the carbon footprint tracker, a user selects an item to purchase at an online merchant on his or her smart phone. In an alternate example, the user selects an item to purchase at a brick-and-mortar store, and scans a code, for example, a UPC code, with the smart phone to identify the item to be purchased. In either example, carbon tracker program 112 then determines the total carbon emissions for the selected product. The total carbon emissions for the selected product includes the carbon emissions for the entire supply chain for the product. This includes the carbon emissions from the manufacturing of the product; the shipment of the product, both to any warehouse(s) that may store the product prior to delivery to the user, as well as the shipment of the product from the warehouse to the user; the storage of the product in the warehouse(s); the packaging materials used for the product; and a percentage of the carbon emissions that would be generated by returning the product, based on the probability that the product would be returned. The total carbon emissions is calculated from data that is found online through a custom web search, or from data stored in the aggregate carbon footprint database, if the user has previously purchased the same or a similar item.

In the example, carbon tracker program 112 also performs a search, both online and in the aggregate carbon footprint database, to find alternative items that are similar to the item the user has initially selected, but have a lower total carbon emissions, which are calculated the same as for the original item selected by the user. Carbon tracker program 112 then opens a popup window on the smart phone to notify the user of the total carbon footprint for the original item the user selected, as well as the alternative items that carbon tracker program 112 located, along with their total carbon emissions. In addition, carbon tracker program 112 displays an aggregate total carbon emissions for any time period that the user selects. This allows the user to track his or her carbon footprint over time, and make purchasing decisions based on the long-term carbon footprint of the purchasing decisions.

In the example, when the user makes a selection, carbon tracker program 112 records the transaction in the aggregate carbon footprint database, and updates the aggregate total carbon emissions in the aggregate carbon footprint database by subtracting the total carbon emissions of the current transaction from the current aggregate total carbon emissions.

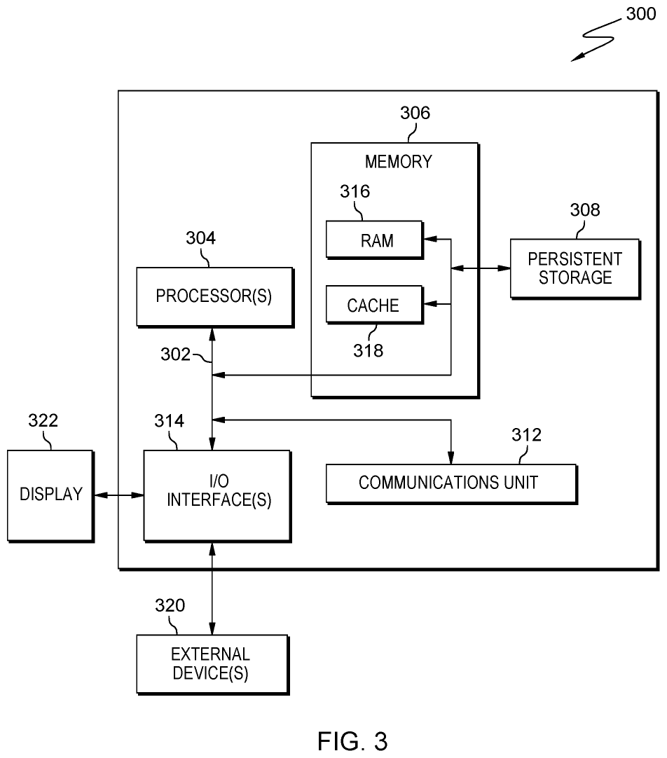

FIG. 3 is a block diagram depicting components of computing device 110 suitable for carbon tracker program 112, in accordance with at least one embodiment of the invention. FIG. 3 displays the computer 300, one or more processor(s) 304 (including one or more computer processors), a communications fabric 302, a memory 306 including, a random-access memory (RAM) 316, and a cache 318, a persistent storage 308, a communications unit 312, I/O interfaces 314, a display 322, and external devices 320. It should be appreciated that FIG. 3 provides only an illustration of one embodiment and does not imply any limitations with regard to the environments in which different embodiments may be implemented. Many modifications to the depicted environment may be made.

As depicted, the computer 300 operates over the communications fabric 302, which provides communications between the computer processor(s) 304, memory 306, persistent storage 308, communications unit 312, and input/output (I/O) interface(s) 314. The communications fabric 302 may be implemented with an architecture suitable for passing data or control information between the processors 304 (e.g., microprocessors, communications processors, and network processors), the memory 306, the external devices 320, and any other hardware components within a system. For example, the communications fabric 302 may be implemented with one or more buses.

The memory 306 and persistent storage 308 are computer readable storage media. In the depicted embodiment, the memory 306 comprises a RAM 316 and a cache 318. In general, the memory 306 can include any suitable volatile or non-volatile computer readable storage media. Cache 318 is a fast memory that enhances the performance of processor(s) 304 by holding recently accessed data, and near recently accessed data, from RAM 316.

Program instructions for carbon tracker program 112 may be stored in the persistent storage 308, or more generally, any computer readable storage media, for execution by one or more of the respective computer processors 304 via one or more memories of the memory 306. The persistent storage 308 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

The communications unit 312, in these examples, provides for communications with other data processing systems or devices. In these examples, the communications unit 312 includes one or more network interface cards. The communications unit 312 may provide communications through the use of either or both physical and wireless communications links. In the context of some embodiments of the present invention, the source of the various input data may be physically remote to the computer 300 such that the input data may be received, and the output similarly transmitted via the communications unit 312.

The I/O interface(s) 314 allows for input and output of data with other devices that may be connected to computer 300. For example, the I/O interface(s) 314 may provide a connection to external device(s) 320 such as a keyboard, a keypad, a touch screen, a microphone, a digital camera, and/or some other suitable input device. External device(s) 320 can also include portable computer readable storage media such as, for example, thumb drives, portable optical or magnetic disks, and memory cards. Software and data used to practice embodiments of the present invention, e.g., carbon tracker program 112, can be stored on such portable computer readable storage media and can be loaded onto persistent storage 308 via the I/O interface(s) 314. I/O interface(s) 314 also connect to a display 322.

Display 322 provides a mechanism to display data to a user and may be, for example, a computer monitor. Display 322 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for a carbon footprint tracker, the computer-implemented method comprising:
responsive to determining that an original transaction to purchase an original item for a user is detected by a computer, calculating, by a one or more computer processors, a total carbon emissions for the original item;
locating, by the one or more computer processors, one or more alternatives to the original item;
calculating, by the one or more computer processors, the total carbon emissions for each alternative of the one or more alternatives to the original item;
notifying, by the one or more computer processors, the user of the total carbon emissions for the original item and the total carbon emissions for each lower carbon emissions item of the one or more alternatives to the original item, wherein the each lower carbon emissions item of the one or more alternatives to the original item has total a carbon emissions lower than the original item; and
receiving, by the one or more computer processors, an indication of a final item chosen by the user, wherein the final item chosen by the user is selected from the group containing the original item and the each lower carbon emissions item of the one or more alternatives to the original item.

2. The computer-implemented method of claim 1, wherein calculating, by the one or more computer processors, the total carbon emissions further comprises:
calculating, by the one or more computer processors, a manufacturer carbon emissions generated by creation of an item;
calculating, by the one or more computer processors, a transportation carbon emissions generated by shipping of the item;
calculating, by the one or more computer processors, a storage carbon emissions generated by warehousing of the item;
calculating, by the one or more computer processors, a return probability carbon emissions based on a return rate the item; and
calculating, by the one or more computer processors, the total carbon emissions for the item based on the manufacturer carbon emissions, the transportation carbon emissions, the storage carbon emissions and the return probability carbon emissions.

3. The computer-implemented method of claim 1, wherein notifying, by the one or more computer processors, the user of the total carbon emissions for the original item and the total carbon emissions for each lower carbon emissions item of the one or more alternatives to the original item further comprises:
notifying, by the one or more computer processors, the user of a total aggregate carbon emissions for the user, wherein the total aggregate carbon emissions for the user is stored in a carbon footprint database for the user; and
responsive to receiving, by the one or more computer processors, the indication of the final item chosen by the user, storing an updated total aggregate carbon emissions in the carbon footprint database for the user, wherein the updated total aggregate carbon emissions in the carbon footprint database for the user is updated based on the total carbon emissions for the final item chosen by the user.

4. The computer-implemented method of claim 1, wherein notifying, by the one or more computer processors, the user of the total carbon emissions for the original item and the total carbon emissions for each lower carbon emissions item of the one or more alternatives to the original item further comprises displaying, by the one or more computer processors, a popup window on the computer to highlight the original item and display the total carbon emissions for the original item.

5. The computer-implemented method of claim 1, wherein notifying, by the one or more computer processors, the user of the total carbon emissions for the original item and the total carbon emissions for each lower carbon emissions item of the one or more alternatives to the original item further comprises displaying a popup window on the computer to display a sorted list of the one or more alternatives to the original item.

6. The computer-implemented method of claim 1 further comprising:
calculating, by the one or more computer processors, a number of points for the final item chosen by the user, wherein the points for the final item are calculated based on the total carbon emissions for the final item;
subtracting, by the one or more computer processors, the number of points for the final item from an aggregate number of points for the user to generate a remaining aggregate number of points for the user;
storing, by the one or more computer processors, the remaining aggregate number of points for the user in a carbon footprint database; and
notifying, by the one or more computer processors, the user of the remaining aggregate number of points.

7. The computer-implemented method of claim 1, wherein calculating, by the one or more computer processors, the total carbon emissions for the final item further comprises calculating a supply chain carbon credit value for the final item.

8. A computer program product for a carbon footprint tracker, the computer program product comprising:
one or more computer readable storage devices and program instructions stored on the one or more computer readable storage devices, the stored program instructions comprising:
responsive to determining that an original transaction to purchase an original item for a user is detected by a computer, program instructions to calculate a total carbon emissions for the original item;
program instructions to locate one or more alternatives to the original item;
program instructions to calculate the total carbon emissions for each alternative of the one or more alternatives to the original item;
program instructions to notify the user of the total carbon emissions for the original item and the total carbon emissions for each lower carbon emissions item of the one or more alternatives to the original item, wherein the each lower carbon emissions item of the one or more alternatives to the original item has a total carbon emissions lower than the original item; and
program instructions to receive an indication of a final item chosen by the user, wherein the final item chosen by the user is selected from the group containing the original item and the each lower carbon emissions item of the one or more alternatives to the original item.

9. The computer program product of claim 8, wherein program instructions to calculate the total carbon emissions further comprises one or more of the following program instructions, stored on the one or more computer readable storage media, to:
calculate a manufacturer carbon emissions generated by creation of an item;
calculate a transportation carbon emissions generated by shipping of the item;
calculate a storage carbon emissions generated by warehousing of the item;
calculate a return probability carbon emissions based on a return rate the item; and
calculate the total carbon emissions for the item based on the manufacturer carbon emissions, the transportation carbon emissions, the storage carbon emissions and the return probability carbon emissions.

10. The computer program product of claim 8, wherein program instructions to notify the user of the total carbon emissions for the original item and the total carbon emissions for each lower carbon emissions item of the one or more alternatives to the original item further comprises one or more of the following program instructions, stored on the one or more computer readable storage media, to:
notify the user of a total aggregate carbon emissions for the user, wherein the total aggregate carbon emissions for the user is stored in a carbon footprint database for the user; and
responsive to receiving an indication of the final item chosen by the user, store an updated total aggregate carbon emissions in the carbon footprint database for the user, wherein the updated total aggregate carbon emissions in the carbon footprint database for the user is updated based on the total carbon emissions for the final item chosen by the user.

11. The computer program product of claim 8, wherein program instructions to notify the user of the total carbon emissions for the original item and the total carbon emissions for each lower carbon emissions item of the one or more alternatives to the original item further comprises program instructions to display a popup window on the computer to highlight the original item and display the total carbon emissions for the original item.

12. The computer program product of claim 8, wherein program instructions to notify the user of the total carbon emissions for the original item and the total carbon emissions for each lower carbon emissions item of the one or more alternatives to the original item further comprises program instructions to display a popup window on the computer to display a sorted list of the one or more alternatives to the original item.

13. The computer program product of claim 8, further comprises one or more of the following program instructions, stored on the one or more computer readable storage media, to:
calculate a number of points for the final item chosen by the user, wherein the points for the final item are calculated based on the total carbon emissions for the final item;
subtract the number of points for the final item from an aggregate number of points for the user to generate a remaining aggregate number of points for the user;
store the remaining aggregate number of points for the user in a carbon footprint database; and
notify the user of the remaining aggregate number of points.

14. The computer program product of claim 8, wherein program instructions to calculate the total carbon emissions for the final item further comprises calculating a supply chain carbon credit value for the final item.

15. A computer system for a carbon footprint tracker, the computer program product comprising:
one or more computer processors;
one or more computer readable storage media; and
program instructions stored on the one or more computer readable storage media for execution by at least one of the one or more computer processors, the stored program instructions comprising:
responsive to determining that an original transaction to purchase an original item for a user is detected by a computer, program instructions to calculate a total carbon emissions for the original item;
program instructions to locate one or more alternatives to the original item;
program instructions to calculate the total carbon emissions for each alternative of the one or more alternatives to the original item;
program instructions to notify the user of the total carbon emissions for the original item and the total carbon emissions for each lower carbon emissions item of the one or more alternatives to the original item, wherein the each lower carbon emissions item of the one or more alternatives to the original item has a total carbon emissions lower than the original item; and
program instructions to receive an indication of a final item chosen by the user, wherein the final item chosen by the user is selected from the group containing the original item and the each lower carbon emissions item of the one or more alternatives to the original item.

16. The computer system of claim 15, wherein program instructions to calculate the total carbon emissions further comprises one or more of the following program instructions, stored on the one or more computer readable storage media, to:
calculate a manufacturer carbon emissions generated by creation of an item;
calculate a transportation carbon emissions generated by shipping of the item;
calculate a storage carbon emissions generated by warehousing of the item;
calculate a return probability carbon emissions based on a return rate the item; and
calculate the total carbon emissions for the item based on the manufacturer carbon emissions, the transportation carbon emissions, the storage carbon emissions and the return probability carbon emissions.

17. The computer system of claim 15, wherein program instructions to notify the user of the total carbon emissions for the original item and the total carbon emissions for each lower carbon emissions item of the one or more alternatives to the original item further comprises one or more of the following program instructions, stored on the one or more computer readable storage media, to:
notify the user of a total aggregate carbon emissions for the user, wherein the total aggregate carbon emissions for the user is stored in a carbon footprint database for the user; and
responsive to receiving an indication of the final item chosen by the user, store an updated total aggregate carbon emissions in the carbon footprint database for the user, wherein the updated total aggregate carbon emissions in the carbon footprint database for the user is updated based on the total carbon emissions for the final item chosen by the user.

18. The computer system of claim 15, wherein program instructions to notify the user of the total carbon emissions for the original item and the total carbon emissions for each lower carbon emissions item of the one or more alternatives to the original item further comprises program instructions to display a popup window on the computer to highlight the original item and display the total carbon emissions for the original item.

19. The computer system of claim 15, wherein program instructions to notify the user of the total carbon emissions for the original item and the total carbon emissions for each lower carbon emissions item of the one or more alternatives to the original item further comprises program instructions to display a popup window on the computer to display a sorted list of the one or more alternatives to the original item.

20. The computer system of claim 15, further comprises one or more of the following program instructions, stored on the one or more computer readable storage media, to:
calculate a number of points for the final item chosen by the user, wherein the points for the final item are calculated based on the total carbon emissions for the final item;
subtract the number of points for the final item from an aggregate number of points for the user to generate a remaining aggregate number of points for the user;
store the remaining aggregate number of points for the user in a carbon footprint database; and
notify the user of the remaining aggregate number of points.
